(19) United States
(12) Patent Application Publication
(10) Pub. No.: US 2019/0087609 A1
(43) Pub. Date: Mar. 21, 2019

(54) METHOD AND SYSTEM FOR CONTROLLING POWER KEY OF TERMINAL

(71) Applicant: Min ZHANG, HuiZhou (CN)

(72) Inventor: Min ZHANG, HuiZhou (CN)

(21) Appl. No.: 15/579,996

(22) PCT Filed: Dec. 26, 2016
(86) PCT No.: PCT/CN2016/112031

§ 371 Date: Dec. 6, 2017

(30) Foreign Application Priority Data
Jun. 15, 2016 (CN) 201610417334.8

(51) Int. Cl. G06F 21/84; G06F 21/60

(52) U.S. Cl. CPC G06F 21/84; G06F 21/60

(57) ABSTRACT

The present disclosure provides a method and a system for controlling a power key of a terminal, where the method includes: determining type of control command when the terminal monitors the control command and the control command is generated when the power key is triggered; the type of the control command is a turn-off screen control command or a turn-on screen control command; and turning on a screen of the terminal and monitoring an unlocked command, unlocking the screen and controlling the screen to display a desktop menu when the unlocked command is monitored.

### BACKGROUND

### 1. Field of the Invention

The present disclosure relates to field of terminals, and more particularly, to a method and a system for controlling a power key of a terminal.

### 2. Description of the Prior Art

With development of smart terminals, smart terminals have structures and functions that are constantly changing. A main function of a power key of a conventional smart terminal is to turn on/off the screen, and turn on/off the conventional smart terminal. After the power key turns off the screen and the power key is used to turn on and unlock the screen, the screen displays an application interface that was used before the screen was turned off. As some applications can display on a locked screen interface, the application can directly display on the screen even when the screen is turned off, and when the screen is turned on, it can leak user information.

### SUMMARY OF THE DISCLOSURE

The present disclosure provides a method and a system for controlling a power key of a terminal capable of improving information security of the terminal.

In order to solve the above technical issue, the technical scheme of the present disclosure is as follows:

A method for controlling a power key of a terminal, where the method comprises:

obtaining an amount of pressing time when the power key is pressed when the terminal monitors a control command, where the control command is generated when the power key is triggered;

comparing the amount of the pressing time with a predetermined time threshold value;

determining a type of the control command if the amount of the pressing time is less than the predetermined time threshold value; wherein the control command is a turn-off screen control command or a turn-on screen control command;

turning on a screen of the terminal and controlling the screen to display a desktop menu when the control command is the turn-on screen control command;

controlling a screen display interface to return to the desktop menu and turning off the screen when the control command is the turn-off screen control command.

Furthermore, in the step for controlling the screen display interface to return to the desktop menu, the step comprises:

quitting an application program displayed on the screen, or providing for an application program that is running in a background of the terminal to return to the desktop menu.

Furthermore, in the step for turning on the screen and controlling the screen to display the desktop menu when the control command is the turn-on screen control command, the step particularly comprises:

turning on the screen and determining whether the screen needs to be unlocked or not when the control command is the turn-on screen control command;

monitoring an unlocked screen command if the screen needs to be unlocked; and

unlocking the screen and controlling the screen to display the desktop menu if the unlocked screen command is monitored.

Furthermore, in the step for monitoring the unlocked screen command, the step comprises:

determining whether the unlocked screen command is monitored or not in a predetermined time;

turning off the screen if the unlocked screen command is not monitored in the predetermined time; and

unlocking the screen and controlling the screen to display the desktop menu if the unlocked screen command is monitored.

A method for controlling a power key of a terminal, where the method comprises:

determining a type of a control command when the terminal monitors the control command, where the control command is generated when the power key is triggered. The type of the control command is a turn-off screen control command or a turn-on screen control command; and

turning on a screen of the terminal and controlling the screen to display a desktop menu when the control command is the turn-on screen control command.

Furthermore, after the step for determining the type of the control command, the method further comprises:

controlling a screen display interface to return to the desktop menu and turning off the screen when the control command is the turn-off screen control command.

Furthermore, in the step for controlling the screen display interface to return to the desktop menu, the step comprises:

quitting an application program displayed on the screen, or providing for an application program that is running in a background of the terminal to return to the desktop menu.

Furthermore, in the step for turning on the screen and controlling the screen to display the desktop menu when the control command is the turn-on screen control command, the step particularly comprises:

turning on the screen and determining whether the screen needs to be unlocked or not when the control command is the turn-on screen control command;

monitoring an unlocked screen command if the screen needs to be unlocked; and

unlocking the screen and controlling the screen to display the desktop menu if the unlocked screen command is monitored.

Furthermore, in the step for monitoring the unlocked screen command, the step comprises:

determining whether the unlocked screen command is monitored or not in a predetermined time;

turning off the screen if the unlocked screen command is not monitored in the predetermined time; and

unlocking the screen and controlling the screen to display the desktop menu if the unlocked screen command is monitored.

Furthermore, in the step for determining the type of the control command when the terminal monitors the control command and the control command is generated when the power key is triggered, the step particularly comprises:

obtaining an amount of pressing time that the power key is pressed when the terminal monitors the control command and the control command is generated when the power key is triggered;

comparing the amount of the pressing time with a predetermined time threshold value; and

determining the type of the control command if the amount of the pressing time is less than the predetermined time threshold value.

Furthermore, in the step for determining the type of the control command when the terminal monitors the control command and the control command is generated when the power key is triggered, the step particularly comprises:

collecting fingerprint information for pressing the power key when the terminal monitors the control command and the control command is generated when the power key is triggered; and

determining the type of the control command according to the fingerprint information.

Furthermore, in the step for turning on the screen and monitoring the unlocked screen command when the control command is the turn-on screen control command, the step particularly comprises:

comparing the fingerprint information with predetermined fingerprint information if the control command is the turn-on screen control command;

unlocking the screen and controlling the screen to display the desktop menu if the fingerprint information is same as the predetermined fingerprint information; and

turning on the screen and monitoring the unlocked screen command if the fingerprint information is not same as the predetermined fingerprint information;

unlocking the screen and controlling the screen to display the desktop menu when the unlocked screen command is monitored.

A system for controlling a power key of a terminal, the system comprises:

a determining module configured to determine a type of a control command when the terminal monitors the control command and the control command is generated when the power key is triggered; where the type of the control command is a turn-off screen control command or a turn-on screen control command; and

a first executing module configured to turn on a screen of the terminal and control the screen to display a desktop menu when the control command is the turn-on screen control command.

Furthermore, the system for controlling the power key of the terminal comprises

a second executing module configured to control a screen display interface to return to the desktop menu and turn off the screen when the control command is the turn-off screen control command.

Furthermore, the second executing module comprises:

a returning unit configured to quit an application program displayed on the screen or provide for an application program that is running in a background of the terminal to return to the desktop menu.

Furthermore, the first executing module comprises:

a turn-on unit configured to turn on the screen and determine whether the screen needs to be unlocked or not when the control command is the turn-on screen control command;

a monitor unit configured to monitor unlocked screen command if the screen needs to be unlocked; and

a first unlocked unit configured to unlock the screen and control the screen to display the desktop menu if the unlocked screen command is monitored.

Furthermore, the monitor unit is configured to:

determine whether the unlocked screen command is monitored or not in a predetermined time;

turn off the screen if the unlocked screen command is not monitored in the predetermined time; and

unlock the screen and control the screen to display the desktop menu if the unlocked screen command is monitored.

Furthermore, the determining module comprises

an obtaining unit configured to obtain an amount of pressing time that the power key is pressed when the terminal monitors the control command and the control command is generated when the power key is triggered;

a time comparing unit configured to compare the amount of the pressing time with a predetermined time threshold value; and

a type determining unit configured to determine the type of the control command if the amount of the pressing time is less than the predetermined time threshold value.

Furthermore, the determining module comprises:

a collect unit configured to collect fingerprint information for pressing the power key when the terminal monitors the control command and the control command is generated when the power key is triggered; and

a determining unit configured to determine the type of the control command according to the fingerprint information.

Furthermore, the first executing module comprises:

a comparing unit configured to compare the fingerprint information with predetermined fingerprint information if the control command is the turn-on screen control command;

a first executing unit configured to unlock the screen and control the screen to display the desktop menu if the fingerprint information is same as the predetermined fingerprint information; and

a second executing unit configured to turn on the screen and monitor the unlocked screen command if the fingerprint information is not same as the predetermined fingerprint information; unlock the screen and control the screen to display the desktop menu when the unlocked screen command is monitored

The present disclosure provides the method and the system for controlling the power key of the terminal, the method comprises: determining the type of the control command when the terminal monitors the control command and the control command is generated when the power key is triggered; the type of the control command is a turn-off screen control command or a turn-on screen control command; and turning on the screen and monitoring an unlocked screen command; unlocking the screen and controlling the screen to display a desktop menu when the unlocked screen command is monitored. The present disclosure uses the power key to turn on the screen, unlock the screen, and control the screen to display the desktop menu, further improving information security of the terminal.

### BRIEF DESCRIPTION OF THE DRAWINGS

FIG. 1 is a flowchart of a method for controlling a power key of a terminal according to a preferred embodiment of the present disclosure.

FIG. 2 is a structural schematic diagram of a system for controlling a power key of a terminal according to the present disclosure.

### DETAILED DESCRIPTION

The present disclosure provides a method and a system for controlling a power key of a terminal. In order to more clearly and definitely illustrate aim, the technical scheme and effects of the present disclosure, the present disclosure will further be described in detail according to the drawing. It should be understood that the present disclosure has been described with reference to certain preferred and alternative embodiments which are intended to be exemplary only and do not limit the full scope of the present disclosure.

The present disclosure will further be described in detail in accordance with the figures and the exemplary examples.

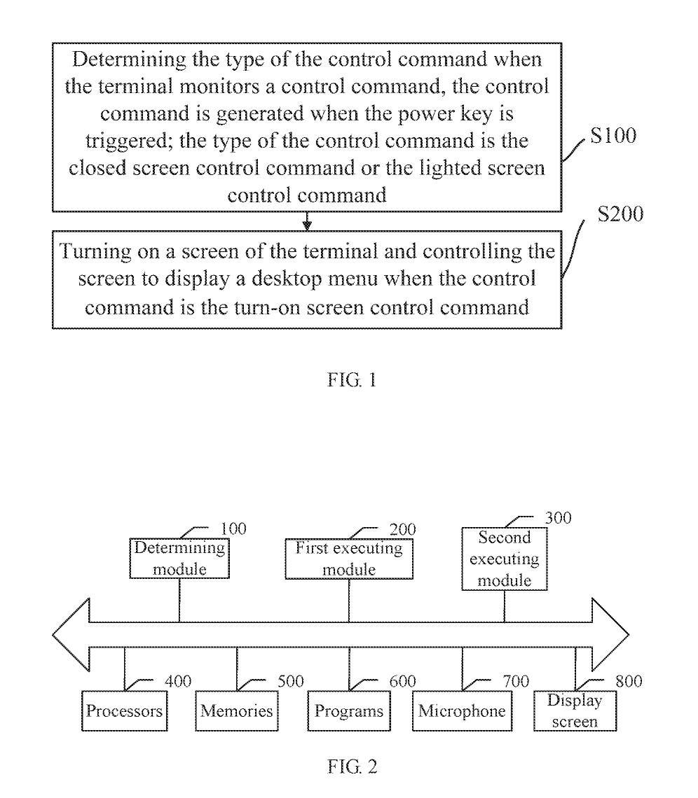

As shown in FIG. 1, FIG. 1 is a flowchart of the method for controlling the power key of the terminal according to a preferred embodiment of the present disclosure, the method comprises:

S100: determining a type of a control command when the terminal monitors a control command, where the control command is generated when the power key is triggered. The type of the control command is a turn-off screen control command or a turn-on screen control command.

To be specific, the terminal is a smart terminal device having a power key, such as phones, IPODS. The terminal monitors the control command in real-time, where the control command is generated when the power key is triggered. The control command can be the turn-off screen control command, the turn-on screen control command, a turn-off terminal control command, and a turn-on terminal control command. In the embodiment, the control command is the turn-off screen control command or the turn-on screen control command. Thus, when the terminal monitors the control command, the determining the type of the control command refers to determining the turn-off screen control command or determining the turn-on screen control command.

Furthermore, the control command that is generated when the power key is triggered further can be the turn-off terminal control command and the turn-on terminal control command. Thus, in order to avoid the terminal from monitoring the turn-off terminal control command and the turn-on terminal control command, before determining the type of the control command, the method further comprises a time detection process, which is:

obtaining an amount of pressing time that the power key is pressed when the terminal monitors the control command and the control command is generated when the power key is triggered;

comparing the amount of the pressing time with a predetermined time threshold value; and

determining the type of the control command if the amount of the pressing time is less than a predetermined time threshold value.

To be specific, the predetermined time threshold value is set in advance by the system to determine the type of the control command is not turn-off/on terminal control command. Thus, the predetermined time threshold value can be turn-off/on terminal time using clicking the power key and is set by terminal factory. Namely, when the amount of the pressing time is greater or equal to the predetermined time threshold value, the control command is the turn-off/on terminal control command, and the terminal is directly turned off/on according to the control command. For example, the predetermined time threshold value is 0.5 seconds.

The method for controlling the power key of the terminal in the present disclosure is regarded as a function. When the terminal monitors the control command and the control command is generated when the power key is triggered, before determining the type of the control command, the method further comprises: determining whether the power control function starts or not. When the power control function starts, the terminal can monitor the control command and the control command is generated when the power key is triggered and the type of the control command is determined, then corresponding operation is executed according to the type of the control command. When the power control function does not start, the terminal executes corresponding operation according to control function of the power key. In practical application, the control function of the power key is set by a setting interface of the terminal, namely the setting interface provides a setting item for the control function of the power key. When the user clicks the setting item and enters the setting interface that is the control function of the power key, switch of the control function of the power key can be set and correlation coefficient of the power key also can be set on the setting interface, such as, the predetermined time threshold value. It should be understood that the terminal can set a key to control the power key to switch the control function of the power key.

S200: turning on a screen of the terminal and controlling the screen to display a desktop menu when the control command is the turn-on screen control command.

To be specific, turning on the screen and controlling the screen to display the desktop menu refers to turning on the screen and only displaying content of an unlocked interface (namely do not display any application interface). The step for turning on the screen and controlling the screen to display a desktop menu practically comprises: turning on the screen and determining whether the screen needs to be unlocked. If the screen needs to be unlocked, the terminal monitors the unlocked screen command. Monitoring the unlocked screen command is regarded as monitoring the correct unlocked screen command, namely, after monitoring the unlocked screen command, the step 200 further comprises determining whether the unlocked screen command is correct or not. The step for determining whether the unlocked screen command is correct or not and step for unlocking the screen belong to ordinary skill in the art, there will not be described. Unlocking the screen and displaying desktop menu refers to unlocking the screen and controlling the screen to display the desktop menu. Namely, the screen is unlocked, at the same time, the application interface displayed on the screen is running in a background of the terminal and the screen returns to main menu interface.

In the embodiment, when the control command is the turn-on screen control command, after turning on the screen, the method comprises: determining whether the terminal need to unlock the screen or not, if the screen needs to be unlocked, unlocked screen command is monitored in a predetermined time and the screen is controlled to display the desktop menu according to the unlocked screen command.

In the step for monitoring the unlocked screen command, the step particularly comprises:

turning on the screen when the control command is the turn-on screen control command;

determining whether the unlocked screen command is monitored or not in the predetermined time, if the unlocked screen command is not monitored in the predetermined time, the screen is turned off; if the unlocked screen command is monitored, the screen is unlocked and the screen is controlled to display the desktop menu.

In the embodiment, in the step for determining whether the unlock the screen command is monitored or not in the predetermined time using a timer to execute, the step particularly comprises:

turning on the screen and starting the timer when the control command is the turn-on screen control command;

turning off the screen when the timer is time-out;

unlocking the screen and controlling the screen to display the desktop menu when the timer is not time-out.

The timer is used to determine whether the screen is turned off or not in the predetermined time. The predetermined time is set in advance. The predetermined time is also can be set on the setting interface that is the control function of the power key. The predetermined time can be set according to the user requirements. In practical application, the predetermined time is preferred to the time that the terminal turns off the screen.

In the step for determining the terminal is unlocked or not, the step particularly comprises: turning on the screen when the control command is the turn-on control command; determining whether the screen needs to be unlocked or not, if the screen needs to be unlocked, the unlocked command is monitored; if the screen does not need to be unlocked, the screen is controlled to display the desktop menu.

In another embodiment, the method for controlling the power key of the terminal further comprises:

S300: controlling a screen display interface to return to the desktop menu and turning off the screen when the control command is the turn-off screen control command.

To be specific, when the control command is the turn-off screen control command, when the application program displayed on the screen is running in the background of the terminal and the screen is turned off. It should be understood, in order to save energy consumption of the terminal, when the control command is the turn-off screen control command, the application program displayed by the screen is quitted, the screen displays the desktop menu, and the screen is turned off.

In another embodiment, the method for controlling the power key of the terminal is applied to a terminal device comprising a fingerprint reader built-in the power key, the method comprises:

S10: collecting fingerprint information for pressing the power key when the terminal monitors the control command and the control command is generated when the power key is triggered;

S20: determining the control command is the turn-off screen control command or the turn-on screen control command; if the control command is the turn-on screen control command, executing S30; if the control command is the turn-off screen control command, executing S60;

S30: comparing the fingerprint information with predetermined fingerprint information; if the fingerprint information is same as the predetermined fingerprint information, executing S50; if the fingerprint information is not same as the predetermined fingerprint information, executing S40;

S40: turning on the screen and monitoring the unlocked screen command; if the unlocked screen command is monitored, executing S50; if the unlocked screen command is not monitored, the screen is turned off;

S50: unlocking the screen and controlling the screen to display the desktop menu;

S60: controlling the screen display interface to display the desktop menu and turning off the screen.

The present disclosure further provides a system for controlling the power key of the terminal, as shown in FIG. 2, the system comprises:

a determining module 100, a first executing module 200, a second executing module 300, one or more processors 400, one or more memories 500 for computer readable storage media, one or more programs 600 storing in the memories 500, a microphone 700 and a display screen 800 and so on. A person skilled in the art should understand that the system structure as shown in FIG. 2 does not limit the system, and the system can comprises more or less components than the system structure as shown in FIG. 2, some components combined, or different components arranged.

In the embodiment, the processors 400 in the system provide executable procedure code corresponding to the one or more application programs to load in the memories 500. The processors 400 operate the programs 600 storing in the memories 500 to execute the above method for controlling the power key of the terminal, further achieving corresponding functions.

To be specific, a determining module 100 is configured to determine the type of the control command when the terminal monitors the control command and the control command is generated when the power key is triggered. The type of the control command is the turn-off screen control command or the turn-on screen control command.

A first executing module 200 is configured to turn on the screen of the terminal and control the screen to display the desktop menu when the control command is the turn-on screen control command.

A second executing module 300 is configured to control a screen display interface to return to the desktop menu and turn off the screen when the control command is the turn-off screen control command.

In the system for controlling the power key of the terminal, the determining module comprises: a collect unit configured to collect fingerprint information for pressing the power key when the terminal monitors the control command and the control command is generated when the power key is triggered; and a determining unit configured to determine the type of the control command.

In the system for controlling the power key of the terminal, the first executing module comprises:

a comparing unit configured to compare the fingerprint information with predetermined fingerprint information if the control command is the turn-on screen control command;

a first executing unit configured to unlock the screen and control the screen to display the desktop menu if the fingerprint information is same as the predetermined fingerprint information; and

a second executing unit configured to turn on the screen and monitor the unlocked screen command if the fingerprint information is not same as the predetermined fingerprint information; unlock the screen and control the screen to display the desktop menu when the unlocked screen command is monitored.

The present disclosure further provides the terminal. A fingerprint reader is built-in the power key of the terminal. The terminal comprises the above the system.

It is understood that the system and the method disclosed in the present embodiment can be realized by other ways. The illustrated device according to the present embodiment is exemplary. For example, the separated modules are divided based on their functions. Practically, it can be realized that some units or modules disclosed in the present disclosure can be combined or integrated as another system, or some features can be ignored or unexecuted. In addition, a connection, direct couple, or communication between the units or modules, as illustrated or discussed in the present embodiments, can be through some interfaces. An indirect couple or communication between the units or modules is by means of an electrical or mechanical interface or in other manners.

The respective units illustrated in the description can be physically separated or not physically separated. The respective units illustrated in the description can be physical units or not physical units. In other words, the respective units can be integrated in a single chip or physically separated in various network units. Part or all of the units illustrated in the description are selected to realize the purpose of the present disclosure depending on the requirements of the designer.

In addition, the various functional modules may be integrated into a processing chip, or the various modules may physically exist individually, or two or more than two modules may be integrated into a module. The integrated module may be implemented by using hardware, or may be implemented by using a software functional module.

If the integrated module is implemented by using the software functional modules, it may be stored in a computer readable storage medium. The software functional modules are implemented by program instructions stored in a computer device, e.g. a laptop computer, a server, or a network device. A processor of the computer device executes the program instructions to perform steps of the method according to the embodiment of the present disclosure. The storage medium is, for example, a USB storage, an external hard drive, a read-only memory, a random access memory (RAM), a magnetic disk, or an optical disk, etc.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A method for controlling a power key of a terminal, comprising:
obtaining an amount of pressing time that the power key is pressed when the terminal monitors a control command, wherein the control command is generated when the power key is triggered;
comparing the amount of the pressing time with a predetermined time threshold value;
determining a type of the control command if the amount of the pressing time is less than the predetermined time threshold value; wherein the control command is a turn-off screen control command or a turn-on screen control command;
turning on a screen of the terminal and controlling the screen to display a desktop menu when the control command is the turn-on screen control command;
controlling a screen display interface to return to the desktop menu and turning off the screen when the control command is the turn-off screen control command.

2. The method for controlling the power key of the terminal as claimed in claim 1, wherein in the step for controlling the screen display interface to return to the desktop menu, the step comprising:
quitting an application program displayed on the screen, or providing for an application program that is running in a background of the terminal to return to the desktop menu.

3. The method for controlling the power key of the terminal as claimed in claim 1, wherein in the step for turning on the screen and controlling the screen to display the desktop menu when the control command is the turn-on screen control command, the step comprising:
turning on the screen and determining whether the screen needs to be unlocked or not when the control command is the turn-on screen control command;
monitoring an unlocked screen command if the screen needs to be unlocked; and
unlocking the screen and controlling the screen to display the desktop menu if the unlocked screen command is monitored.

4. The method for controlling the power key of the terminal as claimed in claim 3, wherein in the step for monitoring the unlocked screen command, the step comprising:
determining whether the unlocked screen command is monitored or not in a predetermined time;
turning off the screen if the unlocked screen command is not monitored in the predetermined time; and
unlocking the screen and controlling the screen to display the desktop menu if the unlocked screen command is monitored.

5. A method for controlling a power key of a terminal, comprising:
determining a type of a control command when the terminal monitors the control command and the control command is generated when the power key is triggered, wherein the type of the control command is a turn-off screen control command or a turn-on screen control command; and
turning on a screen of terminal and controlling the screen to display a desktop menu when the control command is the turn-on screen control command.

6. The method for controlling the power key of the terminal as claimed in claim 5, wherein after the step for determining the type of the control command, the method further comprising:
controlling a screen display interface to return to the desktop menu and turning off the screen when the control command is the turn-off screen control command.

7. The method for controlling the power key of the terminal as claimed in claim 6, wherein in the step for controlling the screen display interface to return to the desktop menu, the step comprising:
quitting an application program displayed on the screen, or providing for an application program that is running in a background of the terminal to return to the desktop menu.

8. The method for controlling the power key of the terminal as claimed in claim 5, wherein in the step for turning on the screen and controlling the screen to display the desktop menu when the control command is the turn-on screen control command, the step comprising:
turning on the screen and determining whether the screen needs to be unlocked or not when the control command is the turn-on screen control command;
monitoring an unlocked screen command if the screen needs to be unlocked; and
unlocking the screen and controlling the screen to display the desktop menu if the unlocked screen command is monitored.

9. The method for controlling the power key of the terminal as claimed in claim 8, wherein in the step for monitoring the unlocked screen command, the step comprising:
determining whether the unlocked screen command is monitored or not in a predetermined time;
turning off the screen if the unlocked screen command is not monitored in the predetermined time; and
unlocking the screen and controlling the screen to display the desktop menu if the unlocked screen command is monitored.

10. The method for controlling the power key of the terminal as claimed in claim 5, wherein in the step for determining the type of the control command when the terminal monitors the control command and the control command is generated when the power key is triggered, the step comprising:
obtaining an amount of pressing time that the power key is pressed when the terminal monitors the control command and the control command is generated when the power key is triggered;
comparing the amount of the pressing time with a predetermined time threshold value; and
determining the type of the control command if the amount of the pressing time is less than the predetermined time threshold value.

11. The method for controlling the power key of the terminal as claimed in claim 5, wherein in the step for determining the type of the control command when the terminal monitors the control command and the control command is generated when the power key is triggered, the step comprising:
collecting fingerprint information for pressing the power key when the terminal monitors the control command and the control command is generated when the power key is triggered; and
determining the type of the control command according to the fingerprint information.

12. The method for controlling the power key of the terminal as claimed in claim 11, wherein in the step for turning on the screen and controlling the screen to display the desktop menu when the control command is the turn-on screen control command, the step comprising:
comparing the fingerprint information with predetermined fingerprint information if the control command is the turn-on screen control command;
unlocking the screen and controlling the screen to display the desktop menu if the fingerprint information is same as the predetermined fingerprint information; and
turning on the screen and monitoring the unlocked screen command if the fingerprint information is not same as the predetermined fingerprint information;
unlocking the screen and controlling the screen to display the desktop menu when the unlocked screen command is monitored.

13-20. (canceled)

21. A terminal comprising system, a power key, a screen, one or more processors, a memory, wherein one or more programs are stored in the memory, wherein the one or more processors executes a method, the method comprising:
monitoring a control command generated when the power key is triggered, and determining a type of the control command, wherein the type of the control command is a turn-off screen control command or a turn-on screen control command; and
turning on the screen of terminal and controlling the screen to display a desktop menu when the control command is the turn-on screen control command.

22. The terminal as claimed in claim 21, wherein after the step for determining the type of the control command, the method further comprising:
controlling a screen display interface of the screen to return to the desktop menu and turning off the screen when the control command is the turn-off screen control command.

23. The terminal as claimed in claim 22, wherein in the step for controlling the screen display interface to return to the desktop menu, the step comprising:
quitting an application program displayed on the screen, or providing for an application program that is running in a background of the terminal to return to the desktop menu.

24. The terminal as claimed in claim 21, wherein in the step for turning on the screen and controlling the screen to display the desktop menu when the control command is the turn-on screen control command, the step comprising:
turning on the screen and determining whether the screen needs to be unlocked or not when the control command is the turn-on screen control command;
monitoring an unlocked screen command if the screen needs to be unlocked; and
unlocking the screen and controlling the screen to display the desktop menu if the unlocked screen command is monitored.

25. The terminal as claimed in claim 24, wherein in the step for monitoring the unlocked screen command, the step comprising:
determining whether the unlocked screen command is monitored or not in a predetermined time;
turning off the screen if the unlocked screen command is not monitored in the predetermined time; and
unlocking the screen and controlling the screen to display the desktop menu if the unlocked screen command is monitored.

26. The terminal as claimed in claim 21, wherein in the step for determining the type of the control command when the terminal monitors the control command and the control command is generated when the power key is triggered, the step comprising:
obtaining an amount of pressing time that the power key is pressed when the terminal monitors the control command and the control command is generated when the power key is triggered;
comparing the amount of the pressing time with a predetermined time threshold value; and
determining the type of the control command if the amount of the pressing time is less than the predetermined time threshold value.

27. The terminal for controlling the power key of the terminal as claimed in claim 21, wherein in the step for determining the type of the control command when the terminal monitors the control command and the control command is generated when the power key is triggered, the step comprising:
collecting fingerprint information for pressing the power key when the terminal monitors the control command and the control command is generated when the power key is triggered; and
determining the type of the control command according to the fingerprint information.

28. The terminal as claimed in claim 27, wherein in the step for turning on the screen and controlling the screen to display the desktop menu when the control command is the turn-on screen control command, the step comprising:
comparing the fingerprint information with predetermined fingerprint information if the control command is the turn-on screen control command;
unlocking the screen and controlling the screen to display the desktop menu if the fingerprint information is same as the predetermined fingerprint information; and
turning on the screen and monitoring the unlocked screen command if the fingerprint information is not same as the predetermined fingerprint information; unlocking the screen and controlling the screen to display the desktop menu when the unlocked screen command is monitored.
